(19) United States
(12) Patent Application Publication
(10) Pub. No.: US 2015/0074233 A1
(43) Pub. Date: Mar. 12, 2015

(54) METHOD FOR PROVIDING STREAMING SERVICE AND ELECTRONIC DEVICE THEREOF

(71) Applicant: Samsung Electronics Co., Ltd., Gyeonggi-do (KR)

(72) Inventors: Hyun-Suk WON, Seoul (KR); Eun-Jung Hyun, Seoul (KR); Seung-Bum Lee, Gyeonggi-do (KR); Jin-Bong Ryu, Gyeonggi-do (KR); Brian Cheon, Gyeonggi-do (KR)

(73) Assignee: Samsung Electronics Co., Ltd., Gyeonggi-do (KR)

(21) Appl. No.: 14/258,562

(22) Filed: Apr. 22, 2014

(30) Foreign Application Priority Data
Sep. 6, 2013 (KR) 10-2013-0107403

(51) Int. Cl. H04L 29/06

(52) U.S. Cl. CPC H04L 65/60
USPC 709/219

(57) ABSTRACT

An apparatus and method for providing a streaming service in an electronic device are provided. The method includes determining status information of the electronic device, determining data quality for the streaming service based on the status information of the electronic device, transmitting the data quality to a server for the streaming service, and providing the streaming service using streaming data provided from the server.

### PRIORITY

The present application claims priority under 35 U.S.C. §119(a) to a Korean Patent Application filed in the Korean Intellectual Property Office on Sep. 6, 2013 and assigned Serial No. 10-2013-0107403, the contents of which are incorporated herein by reference.

### BACKGROUND OF THE INVENTION

1. Field of the Invention

The present invention relates generally to an apparatus and a method for providing a streaming service in an electronic device.

2. Description of the Related Art

With the advances in Information Telecommunication (IT) and semiconductor technologies, electronic devices can provide various multimedia services in addition to the conventional voice call services.

To provide a seamless streaming service with excellent picture quality, the electronic device detects a streaming data quality optimal to a network speed with a server. The server creates streaming data corresponding to data quality requested by the electronic device, transmits the streaming data to the electronic device, and provides a streaming service to the electronic device.

When the electronic device provides a streaming service of a quality optimal to a network speed, a quality of streaming data optimal to the network speed can act as a load on a network for the streaming service.

Also, because the electronic device determines a quality of streaming data in consideration of a status of the network for the streaming service, the streaming service can cause an unnecessary waste of resources. For example, the electronic device can request streaming data of a resolution of 1080 pixels in accordance to the status of the network for the streaming service. However, when the electronic device supports a resolution of maximum 480 pixels, there can be a problem that the electronic device requests unplayable high-quality streaming data and unnecessarily wastes resources.

### SUMMARY OF THE INVENTION

The present invention has been made to address at least the above-mentioned problems and/or disadvantages in the prior art and to provide at least the advantages described below.

Accordingly, an aspect of the present invention is to provide an apparatus and a method for providing a streaming service in an electronic device.

Another aspect of the present invention is to provide an apparatus and method for requesting and detecting a quality of data for a streaming service in an electronic device.

Another aspect of the present invention is to provide an apparatus and method for detecting a quality of data for a streaming service using a display variable in an electronic device.

Another aspect of the present invention is to provide an apparatus and method for detecting a quality of data for a streaming service using a display variable of an external device in an electronic device.

Another aspect of the present invention is to provide an apparatus and method for detecting a quality of data for a streaming service in consideration of a data usage amount in an electronic device.

Another aspect of the present invention is to provide an apparatus and method for detecting a quality of data for a streaming service in consideration of remaining available data in an electronic device.

Another aspect of the present invention is to provide an apparatus and method for detecting a quality of data for a streaming service in consideration of driving information of a processor in an electronic device.

In accordance with an aspect of the present invention, a method for providing a streaming service in an electronic device includes detecting status information of the electronic device, detecting data quality for the streaming service based on the status information of the electronic device, transmitting the data quality to a server for the streaming service, and providing the streaming service using streaming data provided from the server.

In accordance with an aspect of the present invention, an electronic device includes a display unit configured to display data, a communication unit configured to connect communication with other devices, and a processor configured to detect data quality for a streaming service based on status information of the electronic device, transmit the data quality to a server for the streaming service through the communication unit, and provide the streaming service using streaming data provided from the server through the communication unit.

### BRIEF DESCRIPTION OF THE DRAWINGS

The above and other aspects, features and advantages of the present invention will become more apparent from the following detailed description when taken in conjunction with the accompanying drawings in which:

FIG. 1 illustrates a construction of an electronic device according to an embodiment of the present invention;

FIG. 2 illustrates a construction of a processor according to an embodiment of the present invention;

FIG. 3 illustrates a procedure for detecting a quality of streaming data in an electronic device according to an embodiment of the present invention;

FIG. 4 illustrates a procedure for detecting a quality of streaming data using a display variable for a streaming service in an electronic device according to an embodiment of the present invention;

FIGS. 5A and 5B illustrate a display region for a streaming service in an electronic device according to an embodiment of the present invention;

FIG. 6 illustrates a procedure for detecting a quality of streaming data using a display variable of an external device in an electronic device according to an embodiment of the present invention;

FIG. 7 illustrates a construction for transmitting streaming data to an external device in an electronic device according to an embodiment of the present invention;

FIG. 8 illustrates a procedure for detecting a quality of streaming data using a data usage amount for a streaming service in an electronic device according to an embodiment of the present invention;

FIG. 9 illustrates a construction for transmitting streaming data to an external device according to another embodiment of the present invention;

FIG. 10 illustrates a procedure for detecting a quality of streaming data using remaining available data in an electronic device according to an embodiment of the present invention; and

FIG. 11 illustrates a procedure for detecting a quality of streaming data using a driving variable of a processor in an electronic device according to an embodiment of the present invention.

### DETAILED DESCRIPTION OF EMBODIMENTS OF THE INVENTION

The following description with reference to the accompanying drawings is provided to assist in a comprehensive understanding of various embodiments of the invention as defined by the claims and their equivalents. Although it includes various specific details to assist in that understanding, these are to be regarded as merely examples. Accordingly, those of ordinary skill in the art will recognize that various changes and modifications of the embodiments described herein can be made without departing from the scope and spirit of the invention. In addition, descriptions of well-known functions and constructions may be omitted for the sake of clarity and conciseness.

The terms and words used in the following description and claims are not limited to their dictionary meanings, but are merely used to enable a clear and consistent understanding of the invention. Accordingly, it should be apparent to those skilled in the art that the following description of embodiments of the present invention is provided for illustration purposes only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “substantially” indicates that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

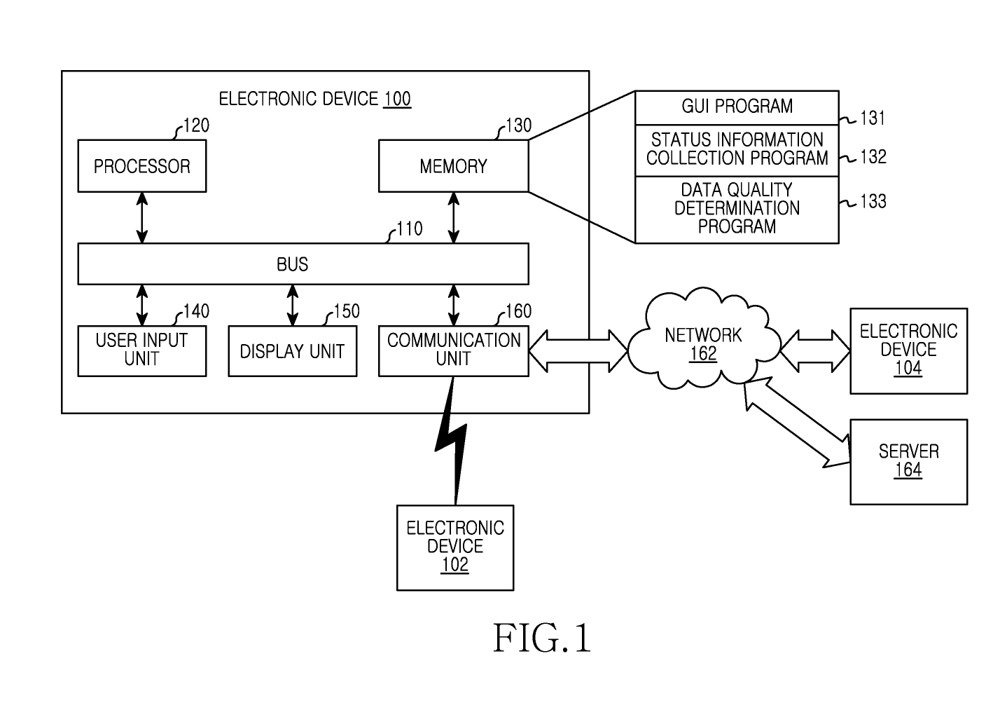

An electronic device of the present invention includes, but is not limited to, one or more of a smart phone capable of a streaming service, a tablet Personal Computer (PC), a mobile phone, a video phone, an electronic book reader, a desktop computer, a laptop computer, a netbook computer, a Personal Digital Assistant (PDA), a Portable Media Player (PMP), an MPEG Audio Layer 3 (MP3) player, accessories, electronic accessories, a camera, a wearable device, a wristwatch, a Television (TV), a Digital Versatile Disc (DVD) player, an audio, an electronic bracelet, an electronic necklace, an air cleaner, an electronic frame, a medical instrument, a navigation device, a Global Positioning System (GPS) receiver, an Event Data Recorder (EDR), a Flight Data Recorder (FDR), a settop box, a TV box, an electronic dictionary, a vehicle infotainment device, a vessel electronic equipment, a flight electronic instrument, a security instrument, an electronic clothes, an electronic locking system, a camcorder, a game console, a Head Mounted Display (HMD), a flat display device, and an electronic album. FIG. 1 illustrates a construction of an electronic device according to an embodiment of the present invention.

Referring to FIG. 1, the electronic device 100 includes a bus 110, a processor 120, a memory 130, a user input unit 140, a display unit 150, and a communication unit 160. One or more of the processor 120 and the memory 130 can exist in plural.

The bus 110 can connect the constituent elements included in the electronic device 100 to one another, and control communication between the constituent elements included in the electronic device 100.

The processor 120 can control the electronic device 100 to provide various services. For example, the processor 120 can decipher instructions received from one or more other constituent elements (e.g., the memory 130, the user input unit 140, the display unit 150, and the communication unit 160) included in the electronic device 100 through the bus 110, and execute operation or data processing according to the deciphered instructions.

The processor 120 can execute one or more programs stored in the memory 130 and control the electronic device 100 to provide various services. The processor 120 can execute a status information collection program 132 and data quality determination program 133 stored in the memory 130, and determines data quality for a streaming service according to status information of the electronic device 100. For example, the processor 120 can detect the data quality for the streaming service using a display variable of a region for displaying the streaming service in the display unit 150. For instance, when the data quality detected using the display variable of the display unit 150 is greater than a reference data quality, the processor 120 can detect the reference data quality as the data quality for the streaming service. The display variable includes one or more of a size of the region for displaying the streaming service, and a resolution and transparency thereof. The reference data quality includes data quality detected based on a network speed for the streaming service.

When interlocking with an external device and providing a streaming service, the processor 120 can detect data quality for the streaming service using a display variable of a region for displaying the streaming service in the external device. For instance, when the data quality detected using the display variable of the external device is greater than a reference data quality, the processor 120 can detect the reference data quality as the data quality for the streaming service.

The processor 120 can detect data quality for a streaming service based on a data usage amount of the electronic device 100. The data usage amount of the electronic device 100 includes one or more of the number of communication links connected to the electronic device 100 and a size of data transmitted/received through each communication link.

The processor 120 can detect data quality for a streaming service based on remaining available data of the electronic device 100. The remaining available data can represent remaining data that the electronic device 100 can use.

The processor 120 can detect data quality for a streaming service based on a change of the driving performance of the processor 120. For instance, when a system temperature is increased equal to or greater than a reference temperature, the performance of the processor 120 can be decreased. Accordingly, the processor 120 can detect the data quality for the streaming service in inverse proportion to the system temperature.

The memory 130 can store an instruction or data received from one or more constituent elements (i.e., the processor 120, the user input unit 140, the display unit 150, and the communication unit 160) included in the electronic device 100 or created by the one or more constituent elements.

The memory 130 can store one or more programs for a service of the electronic device 100. For example, the memory 130 includes one or more of a Graphical User Interface (GUI) program 131, the status information collection program 132, and the data quality determination program 133. The memory 130 can store one or more programs in forms of programming modules such as a kernel, a middleware, an Application Programming Interface (API), and an application.

The GUI program 131 includes at least one software constituent element for providing a graphical user interface to the display unit 150. For example, the GUI program 131 can control to display on the display unit 150 information of an application program driven by the processor 120. Alternatively, according to control of the processor 120, the GUI program 131 can control to display streaming data provided from a server through the communication unit 160, on the display unit 150.

The status information collection program 132 includes at least one software constituent element for collecting status information of the electronic device 100 for detecting data quality for a streaming service. For example, the status information collection program 132 can collect one or more of a display variable of the display unit 150 for displaying the streaming service, a display variable of an external device, a data usage amount of the electronic device 100, remaining available data of the electronic device 100, and driving performance change information of the processor 120.

The data quality determination program 133 includes at least one software constituent element for detecting data quality for a streaming service using status information of the electronic device 100 collected through the status information collection program 132. For example, the data quality determination program 133 can detect data quality for a streaming service using one or more of a display variable of the display unit 150 for displaying the streaming service collected through the status information collection program 132, a display variable of an external device, a data usage amount of the electronic device 100, remaining available data of the electronic device 100, and driving performance change information of the processor 120.

The user input unit 140 can transmit an instruction or data generated by user's selection, to the processor 120 or the memory 130 through the bus 110. For example, the user input unit 140 includes one or more of a keypad including at least one hardware button, and a touch panel sensing touch information.

The display unit 150 can display a picture, an image or data to a user. For example, the display unit 150 can display information of an application program driven by the processor 120.

The communication unit 160 can connect communication between the electronic device 100 and one or more other electronic devices 102 and 104 or a server 164 or one or more peripheral devices. For example, the communication unit 160 can support one or more of a short-range communication protocol (e.g., Wireless Fidelity (WiFi), Bluetooth (BT), Near Field Communication (NFC)) and a network communication (e.g., the Internet, a Local Area Network (LAN), Wide Area Network (WAN), an electrical communication network, a cellular network, a satellite network, and a Plain Old Telephone Service (POTS)).

In the aforementioned embodiment, the processor 120 can execute software constituent elements stored in the memory 130 within one module and detect data quality for a streaming service according to status information of the electronic device 100.

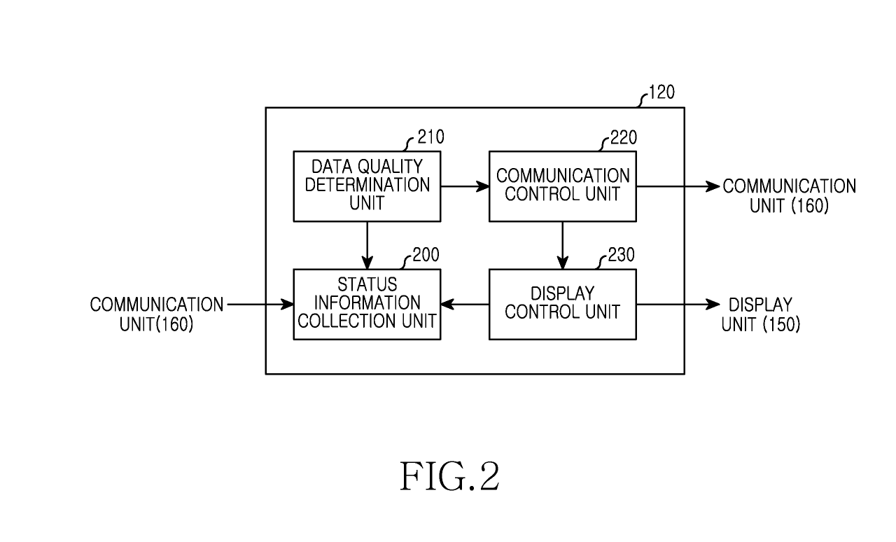

In another embodiment, the processor 120 can be constructed to include, as separate modules, constituent elements for detecting data quality for a streaming service according to status information of the electronic device 100, as illustrated in FIG. 2.

FIG. 2 illustrates a construction of a processor according to an embodiment of the present invention.

Referring to FIG. 2, the processor 120 includes a status information collection unit 200, a data quality determination unit 210, a communication control unit 220, and a display control unit 230.

The status information collection unit 200 can collect status information of the electronic device 100 for detecting data quality for a streaming service. The status information collection unit 200 can execute the status information collection program 132 stored in the memory 130 and collect the status information of the electronic device 100 for detecting the data quality for the streaming service. For example, the status information collection unit 200 can collect one or more of a display variable of the display unit 150 for displaying the streaming service, a display variable of an external device, a data usage amount of the electronic device 100, remaining available data of the electronic device 100, and driving performance change information of the processor 120.

The data quality determination unit 210 can detect data quality for a streaming service using status information of the electronic device 100 collected through the status information collection unit 200. The data quality determination unit 210 can execute the data quality determination program 133 stored in the memory 130 and detect the data quality for the streaming service using the status information of the electronic device 100 collected through the status information collection unit 200. For example, the data quality determination unit 210 can detect the data quality for the streaming service using a display variable of a region for displaying the streaming service in the display unit 150. If the data quality detected using the display variable of the display unit 150 is greater than a reference data quality, the data quality determination unit 210 can detect the reference data quality as the data quality for the streaming service. The reference data quality includes data quality detected based on a network speed for the streaming service.

When interlocking with an external device and providing a streaming service, the data quality determination unit 210 can detect data quality for the streaming service using a display variable of a region for displaying the streaming service in the external device. If the data quality detected using the display variable of the external device is greater than a reference data quality, the data quality determination unit 210 can detect the reference data quality as the data quality for the streaming service.

The data quality determination unit 210 can detect data quality for a streaming service based on a data usage amount of the electronic device 100. The data usage amount of the electronic device 100 includes one or more of the number of communication links connected to the electronic device 100 and a size of data transmitted/received through each communication link.

The data quality determination unit 210 can detect data quality for a streaming service based on remaining available data of the electronic device 100. The remaining available data can represent remaining data that the electronic device 100 can use.

The data quality determination unit 210 can detect data quality for a streaming service based on a change of the driving performance of the data quality determination unit 210. The data quality determination unit 210 can detect the data quality for the streaming service in inverse proportion to a system temperature.

The communication control unit 220 can control communication between the electronic device 100 and a server for a streaming service through the communication unit 160. For example, the communication control unit 220 can transmit data quality for the streaming service detected in the data quality determination unit 210, to a server through the communication unit 160. Alternatively, the communication control unit 220 can receive streaming data for the streaming service from the server through the communication unit 160.

The display control unit 230 can control the display unit 150 to provide a GUI. The display control unit 230 can execute the GUI program 131 stored in the memory 130 and control the display unit 150 to provide the GUI. For example, the display control unit 230 can control to display information of an application program driven by the processor 120 on the display unit 150. Alternatively, according to control of the processor 120, the display control unit 230 can control to display streaming data provided from a server through the communication unit 160, on the display unit 150.

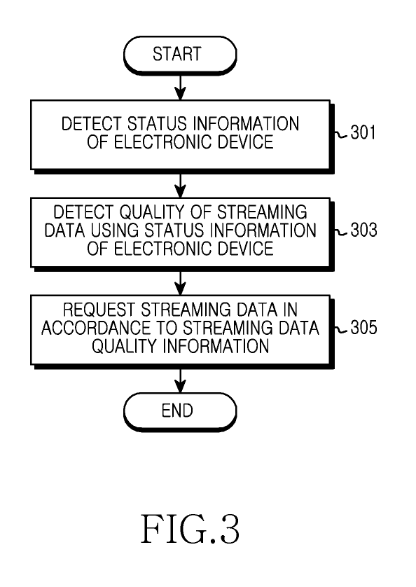

FIG. 3 illustrates a procedure for detecting a quality of streaming data in an electronic device according to an embodiment of the present invention.

Referring to FIG. 3, in step 301, the electronic device determines status information of the electronic device. For example, the electronic device can collect one or more of a display variable of the display unit 150 for displaying a streaming service, a display variable of an external device, a data usage amount of the electronic device, remaining available data of the electronic device, and driving performance change information of the processor 120.

When detecting the status information of the electronic device, in step 303, the electronic device determines a quality of streaming data using the status information of the electronic device. For example, the electronic device can detect data quality for a streaming service using one or more of the display variable of the display unit 150 for displaying the streaming service collected through the status information collection unit 200, the display variable of the external device, the data usage amount of the electronic device, the remaining available data of the electronic device, and the driving performance change information of the processor 120.

In step 305, the electronic device transmits to the server streaming data quality information detected using the status information of the electronic device.

As described above, the electronic device can transmit to the server the streaming data quality information detected using the status information of the electronic device. In this case, the server can create the streaming data corresponding to the streaming data quality information provided from the electronic device and transmit the streaming data to the electronic device.

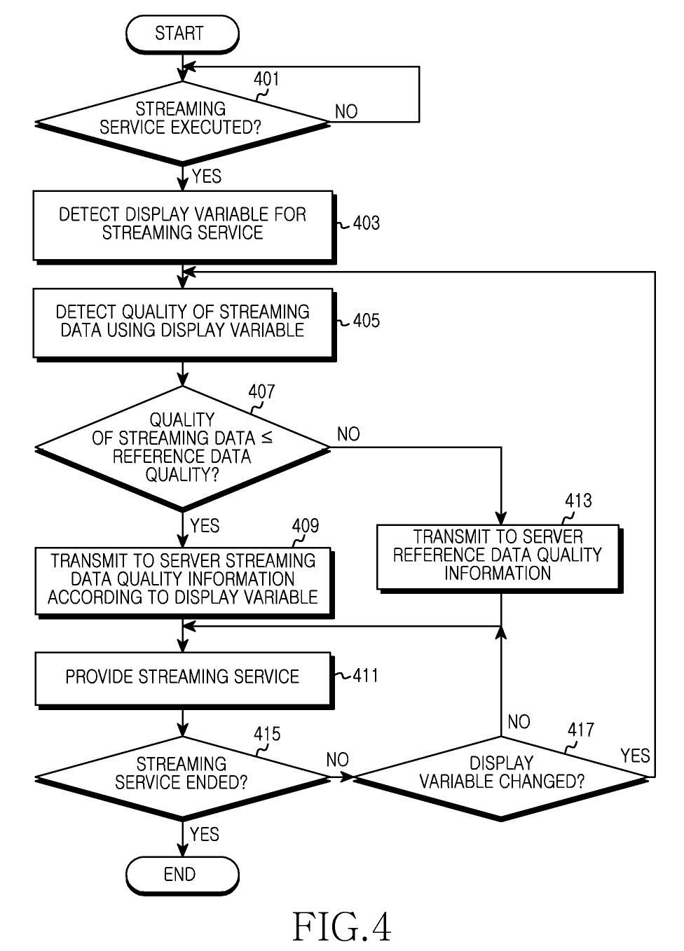

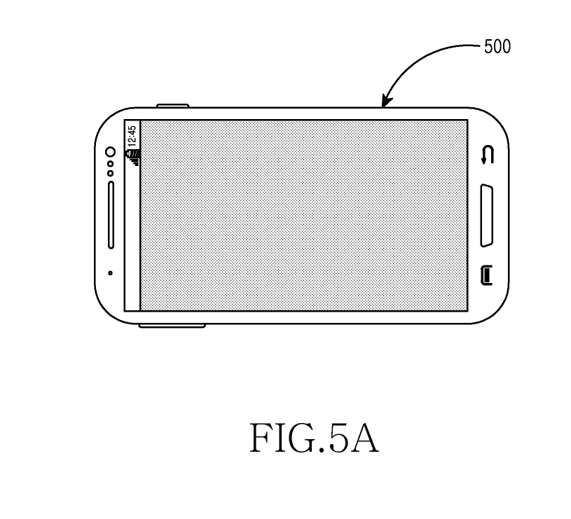

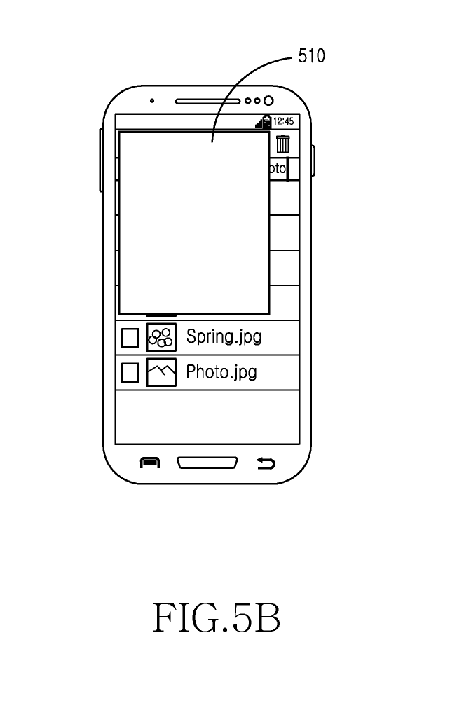

FIG. 4 illustrates a procedure for detecting a quality of streaming data using a display variable for a streaming service in an electronic device according to an embodiment of the present invention. The following description is made for a procedure for detecting a quality of streaming data with reference to a display region for a streaming service illustrated in FIGS. 5A and 5B.

Referring to FIG. 4, in step 401, the electronic device can detect whether an execution event for a streaming service occurs. For example, the electronic device can detect whether an application program for the streaming service is executed in accordance to input information provided through the user input unit 140.

If the execution event for the streaming service occurs, in step 403, the electronic device determines a display variable of a region for displaying the streaming service in the display unit 150. For example, when the electronic device provides the streaming service using the entire region 500 of the display unit 150 as in FIG. 5A, the electronic device can detect one or more display variables among a size of the entire region 500, a resolution thereof, and a transparency thereof. Alternatively, when the electronic device provides the streaming service using a partial region 510 of the display unit 150 as in FIG. 5B, the electronic device can detect one or more display variables among a size, resolution, and transparency of the partial region 510 for providing the streaming service.

In step 405, the electronic device determines a quality of streaming data using the display variable of the region for displaying the streaming service. For example, the electronic device can detect a quality of optimal streaming data capable of providing the streaming service based on the display variable of the region for displaying the streaming service.

After detecting the quality of the streaming data, in step 407, the electronic device compares the quality of the streaming data and a reference data quality. For example, the electronic device can determine whether a streaming data quality value detected in step 405 is less than or equal to a reference data quality value. The reference data quality includes data quality that the electronic device detects based on a network speed for the streaming service.

If the quality of the streaming data is less than or equal to the reference data quality, in step 409, the electronic device sends a server a request for a streaming service corresponding to the quality of the streaming data detected using the display variable of the region for displaying the streaming service. For example, the electronic device can transmit to the server streaming data quality information detected using the display variable of the region for displaying the streaming service.

After sending the server the request for the streaming service, in step 411, the electronic device provides the streaming service using streaming data received from the server. The streaming data received from the server includes streaming data created by the server corresponding to the streaming data quality information requested by the electronic device in step 409.

If the quality of the streaming data is greater than the reference data quality in step 407, in step 413, the electronic device can send the server a request for a streaming service corresponding to the reference data quality. For example, the electronic device can transmit reference data quality information to the server.

After sending the server the request for the streaming service, in step 411, the electronic device provides the streaming service using streaming data received from the server. The streaming data received from the server includes streaming data created by the server corresponding to the reference data quality information requested by the electronic device in step 413.

In step 415, the electronic device determines whether the streaming service is ended.

If the streaming service is ended, the electronic device terminates the algorithm.

If the streaming service is not ended in step 415, in step 417, the electronic device determines whether the display variable of the region for the streaming service in the display unit 150 is changed. For example, the electronic device can detect whether one or more of a size, resolution, and transparency of a display region for the streaming service are changed.

If the display variable of the region for the streaming service in the display unit 150 is not changed, in step 411, the electronic device provides the streaming service using the streaming data received from the server.

If the display variable of the region for the streaming service is changed in step 417, the electronic device returns to step 405 and determines a quality of streaming data using the changed display variable of the region for displaying the streaming service.

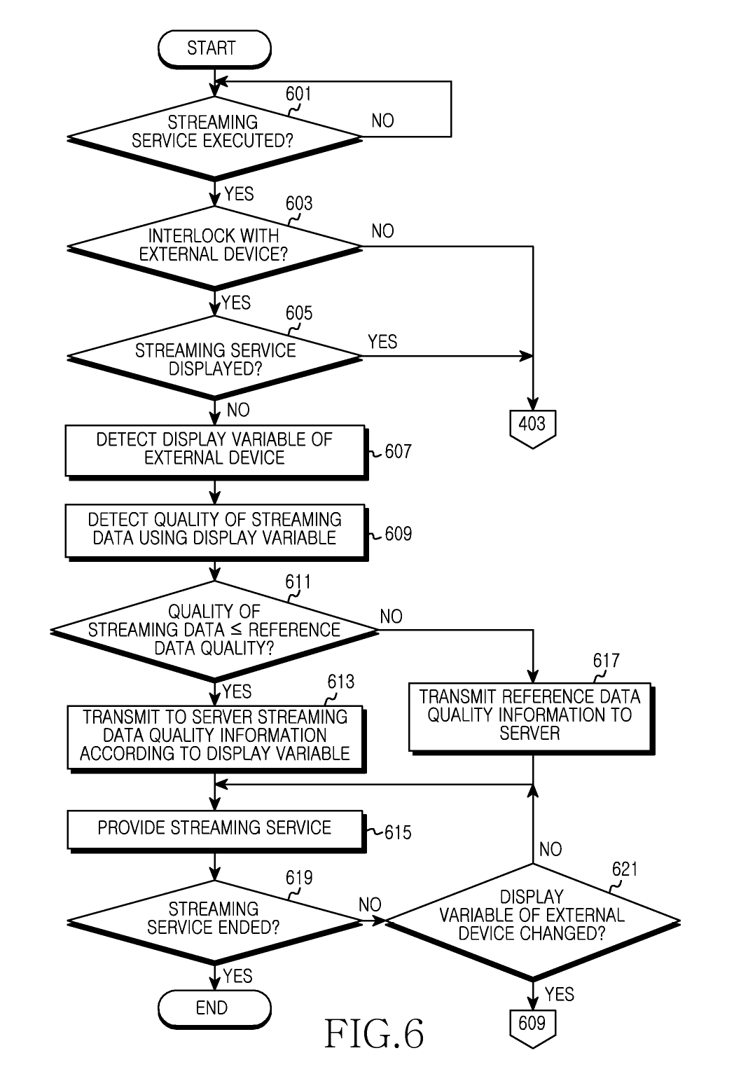

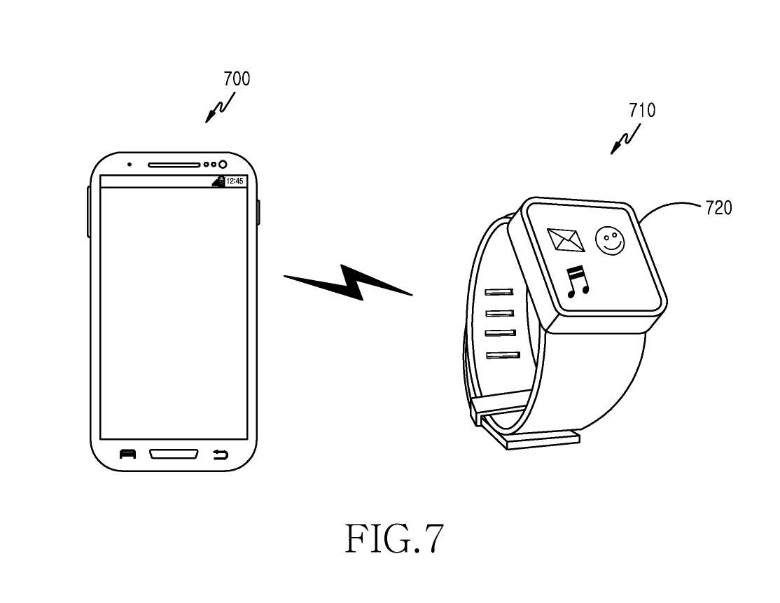

FIG. 6 illustrates a procedure for detecting a quality of streaming data using a display variable of an external device in an electronic device according to an embodiment of the present invention. FIG. 7 illustrates a construction for transmitting streaming data to an external device in an electronic device according to an embodiment of the present invention.

Referring to FIG. 6, in step 601, the electronic device determines whether an execution event for a streaming service occurs. For example, the electronic device can detect whether an application program for the streaming service is executed in accordance to input information provided through the user input unit 140.

When the execution event for the streaming service occurs, in step 603, the electronic device determines whether it interlocks the streaming service with an external device. For example, referring to FIG. 7, the electronic device 700 can detect whether a wearable electronic device 710 for interlocking the streaming service has been connected.

If the streaming service is not interlocked with the external device, the electronic device determines a display variable of a region for displaying a streaming service in the display unit 150 of the electronic device in step 403 of FIG. 4. The display variable includes one or more of a size, resolution, and transparency of the region for displaying the streaming service.

If the streaming service is interlocked with the external device, in step 605, the electronic device determines whether it displays the streaming service in the display unit 150 at the time of streaming service interlocking with the external device.

If the streaming service is displayed in the display unit 150, the electronic device determines the display variable of the region for displaying the streaming service in the display unit 150 of the electronic device in step 403 of FIG. 4.

If the streaming service is not displayed in the display unit 150 in step 605, in step 607, the electronic device determines a display variable of a region for displaying the streaming service in the external device. For example, when interlocking the streaming service with the wearable electronic device 710 as in FIG. 7, the electronic device can detect one or more display variables among a size of a region for the streaming service in a display unit 720 of the wearable electronic device 710, a resolution thereof, and a transparency thereof. Alternatively, when interlocking the streaming service with a Head Mounted Device (HMD), the electronic device can detect a size of a region for the streaming service and a resolution thereof in consideration of a distance between a user and a projection of the HMD.

In step 609, the electronic device determines a quality of streaming data using the display variable of the region for displaying the streaming service in the external device. For example, the electronic device can detect a quality of optimal streaming data capable of providing the streaming service based on the display variation of the region for displaying the streaming service of the external device.

If detecting the quality of the streaming data, in step 611, the electronic device compares the quality of the streaming data and a reference data quality. For example, the electronic device can detect whether a streaming data quality value detected in step 609 of the electronic device is less than or equal to a reference data quality value. The reference data quality includes data quality that the electronic device detects based on a network speed for the streaming service.

If the quality of the streaming data is less than or equal to the reference data quality, in step 613, the electronic device sends a server a request for a streaming service corresponding to the quality of the streaming data detected using the display variable of the region for displaying the streaming service. For example, the electronic device can transmit, to the server, streaming data quality information detected using the display variable of the region for displaying the streaming service.

If sending the server the request for the streaming service corresponding to the quality of the streaming data, in step 615, the electronic device transmits streaming data received from the server, to the external device interlocking the streaming service, and provides the streaming service. The streaming data received from the server includes streaming data created by the server corresponding to the streaming data quality information requested by the electronic device in step 613.

If the quality of the streaming data is greater than the reference data quality in step 611, in step 617, the electronic device sends the server a request for a streaming service corresponding to the reference data quality. For example, the electronic device can transmit reference data quality information to the server.

If sending the server the request for the streaming service corresponding to the reference data quality in step 617, in step 615, the electronic device provides the streaming service using streaming data received from the server. The streaming data received from the server includes streaming data created by the server corresponding to the reference data quality information requested by the electronic device in step 617.

In step 619, the electronic device determines whether the streaming service is ended.

If the streaming service is ended, the electronic device terminates the algorithm.

If the streaming service is not ended in step 619, in step 621, the electronic device determines whether the display variable of the region for the streaming service in the external device is changed. For example, the electronic device determines whether one or more of a size, resolution, and transparency of the region for the streaming service in the external device are changed.

If the display variable of the region for the streaming service in the external device is not changed, in step 615, the electronic device transmits the streaming data received from the server, to the external device interlocking the streaming service, and provides the streaming service.

If the display variable of the region for the streaming service in the external device is changed in step 621, the electronic device returns to step 609 and detects a quality of streaming data using the changed display variable of the region for displaying the streaming service in the external device.

In the aforementioned embodiment, the electronic device can detect the quality of the streaming data based on the display variable of the region for displaying the streaming service in the external device interlocking the streaming service.

In another embodiment, when the electronic device interlocks the streaming service with a plurality of external devices, the electronic device can select the best, worst, or an average streaming data quality among streaming data qualities according to display variables of the external devices.

In the aforementioned embodiment, when the electronic device interlocks the streaming service with the external device while displaying the streaming service in the display unit 150, the electronic device can detect the quality of the streaming data using the display variable of the region for displaying the streaming service in the display unit 150.

In another embodiment, when the electronic device interlocks the streaming service with the external device while displaying the streaming service in the display unit 150, the electronic device can request the streaming service in accordance to the comparison result of the streaming data quality according to the display variable of the display unit 150 and the streaming data quality according to the display variable of the external device. For example, the electronic device can select a relatively good or bad streaming data quality among the streaming data quality according to the display variable of the display unit 150 and the streaming data quality according to the display variable of the external device. The electronic device can request the streaming service to the server in accordance to a comparison result of the data quality for the streaming service and the reference data quality.

In another embodiment, when the electronic device interlocks the streaming service with the external device while displaying the streaming service in the display unit 150, the electronic device can detect the streaming data quality using the display variable of the external device.

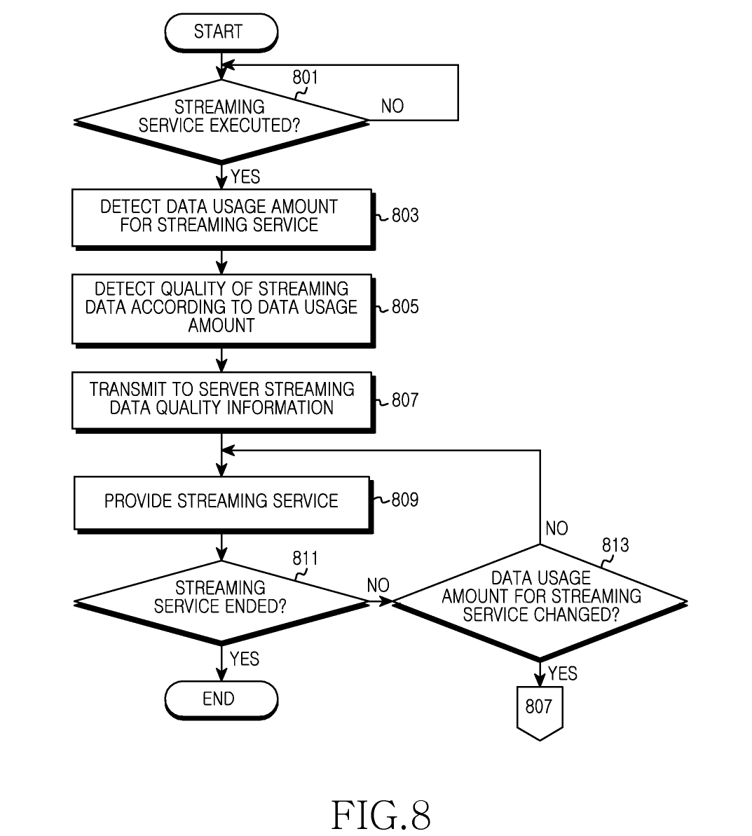

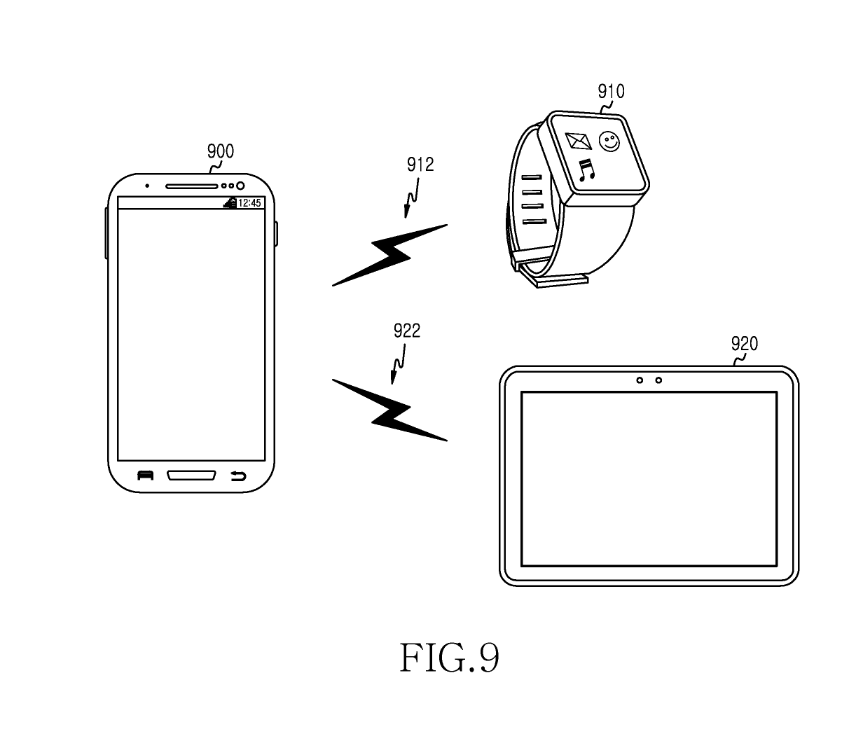

FIG. 8 illustrates a procedure for detecting a quality of streaming data using a data usage amount for a streaming service in an electronic device according to an embodiment of the present invention. FIG. 9 illustrates a construction for transmitting streaming data to an external device according to another embodiment of the present invention.

Referring to FIG. 8, in step 801, the electronic device determines whether an execution event for a streaming service occurs. For example, the electronic device can detect whether an application program for the streaming service is executed in accordance to input information provided through the user input unit 140.

If the execution event for the streaming service occurs, in step 803, the electronic device determines a data usage amount for the streaming service. For example, when the electronic device 900 performs communication with a wearable electronic device 910 and other electronic device 920 as in FIG. 9, the electronic device 900 can use radio resources so as to transmit/receive a signal with the wearable electronic device 910 and the other electronic device 920. Accordingly, the electronic device 900 can detect the data usage amount for providing the streaming service based on the number of radio communication links for transmitting/receiving a signal.

In step 805, the electronic device determines a quality of streaming data based on the data usage amount for providing the streaming service. For example, when the electronic device 900 performs communication with the wearable electronic device 910 and the other electronic device 920 as in FIG. 9, the electronic device 900 can divide a reference data quality by the number (e.g., 3) of communication links and detect the quality of the streaming data. The number of communication links includes a communication link 912 between the electronic device 900 and the wearable electronic device 910, a communication link 922 between the electronic device 900 and the other electronic device 920, and a communication link for the streaming service. Alternatively, when the electronic device 900 transmits a signal in accordance to a broadcast or multicast method, the electronic device 900 can divide the reference data quality by the number (e.g., 2) of communication links and detect the quality of the streaming data. The number of communication links includes a communication link for broadcasting or multicasting a signal and a communication link for the streaming service.

After detecting the quality of the streaming data, in step 807, the electronic device sends a server a request for a streaming service corresponding to the quality of the streaming data detected based on the data usage amount for the streaming service. For example, the electronic device can transmit, to the server, streaming data quality information detected based on the data usage amount for the streaming service.

If the request is sent to the server for the streaming service corresponding to the quality of the streaming data, in step 809, the electronic device provides the streaming service using streaming data received from the server. The streaming data received from the server includes streaming data created by the server corresponding to the streaming data quality information requested by the electronic device in step 807.

In step 811, the electronic device determines whether the streaming service is ended.

If the streaming service is ended, the electronic device terminates the algorithm.

If the streaming service is not ended in step 811, in step 813, the electronic device determines whether the data usage amount for the streaming service is changed. For example, the electronic device can detect whether a communication link is added or removed.

When the data usage amount for the streaming service is not changed, in step 809, the electronic device provides the streaming service using the streaming data received from the server.

When the data usage amount for the streaming service is changed in step 813, the electronic device returns to step 805 and determines a quality of streaming data based on the changed data usage amount for providing the streaming service.

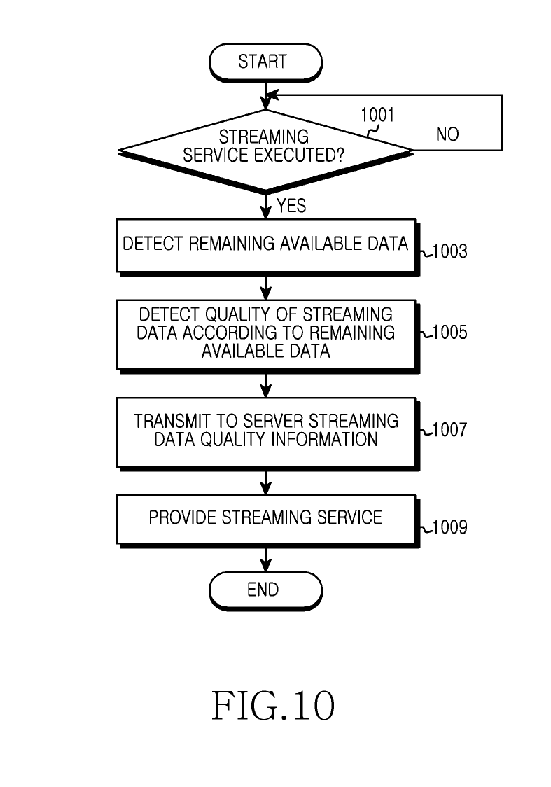

FIG. 10 illustrates a procedure for detecting a quality of streaming data using remaining available data in an electronic device according to an embodiment of the present invention.

Referring to FIG. 10, in step 1001, the electronic device determines whether an execution event for a streaming service occurs. For example, the electronic device can detect whether an application program for the streaming service is executed in accordance to input information provided through the user input unit 140.

When the execution event for the streaming service occurs, in step 1003, the electronic device determines remaining available data of the electronic device. For example, when a usable data amount of the electronic device is restricted, the electronic device can detect the remaining available data usable for the streaming service.

In step 1005, the electronic device determines a quality of streaming data so as to provide the streaming service based on the remaining available data for providing the streaming service.

After determining the quality of the streaming data, in step 1007, the electronic device sends the server a request for a streaming service corresponding to the quality of the streaming data detected based on the remaining available data for the streaming service. For example, the electronic device can transmit streaming data quality information detected based on the remaining available data for the streaming service, to the server.

When sending the server the request for the streaming service corresponding to the quality of the streaming data, in step 1009, the electronic device provides the streaming service using streaming data received from the server. The streaming data received from the server includes streaming data created by the server corresponding to streaming data quality information requested by the electronic device in step 1007.

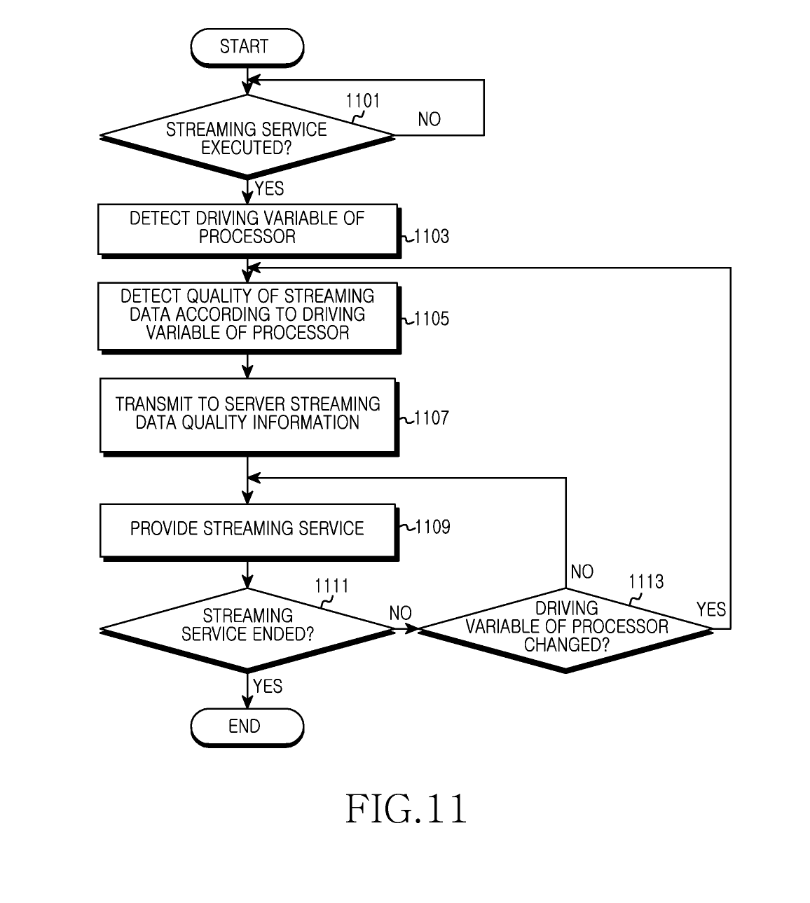

FIG. 11 illustrates a procedure for detecting a quality of streaming data using a driving variable of a processor in an electronic device according to an embodiment of the present invention.

Referring to FIG. 11, in step 1101, the electronic device determines whether an execution event for a streaming service occurs. For example, the electronic device can detect whether an application program for the streaming service is executed in accordance to input information provided through the user input unit 140.

When the execution event for the streaming service occurs, in step 1103, the electronic device determines a driving variable of a processor. For example, the electronic device can detect a system temperature affecting the driving performance of the processor.

In step 1105, the electronic device determines a quality of streaming data based on the driving variable of the processor. For example, the electronic device can estimate the driving performance of the processor in consideration of the driving variable of the processor. Accordingly, the electronic device can determine the quality of the streaming data such that the streaming data can be processed by the driving performance of the processor expected based on the driving variable of the processor.

After determining the quality of the streaming data, in step 1107, the electronic device sends the server a request for a streaming service corresponding to the quality of the streaming data detected based on the driving variable of the processor. For example, the electronic device can transmit, to the server, streaming data quality information detected based on the driving variable of the processor.

If sending the request for the streaming service to the server, in step 1109, the electronic device can provide the streaming service using the streaming data received from the server. The streaming data received from the server includes streaming data created by the server corresponding to the streaming data quality information requested by the electronic device in step 1107.

In step 1111, the electronic device determines whether the streaming service is ended.

If the streaming service is ended, the electronic device terminates the algorithm.

If the streaming service is not ended in step 1111, in step 1113, the electronic device determines whether the driving variable of the processor is changed. For example, the electronic device can detect whether the driving performance of the processor expected based on the driving variable of the processor is changed.

If the driving variable of the processor is not changed, in step 1109, the electronic device provides the streaming service using the streaming data received from the server.

If the driving variable of the processor is changed in step 1113, the electronic device returns to step 1105 and sends the server a request for a streaming service corresponding to a quality of streaming data detected based on the changed driving variable of the processor. For example, the electronic device can transmit, to the server, streaming data quality information detected based on the driving variable of the processor.

It will be appreciated that embodiments of the present invention according to the claims and description in the specification can be realized in the form of hardware, software or a combination of hardware and software.

Any such software may be stored in a computer readable storage medium that stores one or more programs (software modules), the one or more programs comprising instructions, which when executed by one or more processors in an electronic device, cause the electronic device to perform a method of the present invention.

Any such software may be stored in the form of volatile or non-volatile storage such as, for example, a Read-Only Memory (ROM), whether erasable, rewritable or neither, or in the form of memory such as, for example, Random Access Memory (RAM), memory chips, device or integrated circuits or on an optically or magnetically readable medium such as, for example, a Compact Disc (CD), Digital Video Disc (DVD), magnetic disk or magnetic tape or the like. It will be appreciated that the storage devices and storage media are embodiments of machine-readable storage that are suitable for storing a program or programs comprising instructions that, when executed, implement embodiments of the present invention.

Accordingly, embodiments provide a program comprising code for implementing apparatus or a method as claimed in any one of the claims of this specification and a machine-readable storage storing such a program. Still further, such programs may be conveyed electronically via any medium such as a communication signal carried over a wired or wireless connection and embodiments suitably encompass the same.

As described above, embodiments of the present invention can reduce an unnecessary resource waste caused by a streaming service and can provide a stable multitasking service, by detecting a quality of data for the streaming service in consideration of one or more of a display variable for the streaming service, a distance with an external device, a radio resource usage amount, remaining available data, and driving information of a processor.

While the invention has been shown and described with reference to certain embodiments thereof, the order of operations of an electronic device can be changed or merged or reused and various changes such as omission and the like can be made without departing from the spirit and scope of the invention. Therefore, the scope and spirit of the invention should not be defined limited to the described embodiments and should be defined by the appended claims and equivalents to the claims.

What is claimed is:

1. A method in an electronic device, the method comprising:
detecting status information of the electronic device;
detecting data quality for the streaming service based on the detected status information;
transmitting the detected data quality to a server for the streaming service; and
providing the streaming service using streaming data provided from the server.

2. The method of claim 1, wherein the status information of the electronic device comprises one or more of a display variable of a region for displaying the streaming service, a number of communication links, remaining available data, and driving performance of a processor.

3. The method of claim 2, wherein the display variable comprises one or more of a display variable of a region for displaying the streaming service in a display unit of the electronic device, and display variables of regions for displaying the streaming service in display units of one or more external devices interlocking the streaming service with the electronic device.

4. The method of claim 2, wherein the display variable comprises one or more of a size, resolution, and transparency of a region for displaying the streaming service.

5. The method of claim 2, wherein the number of communication links comprises a number of at least one communication link through which the electronic device transmits/receives a signal with at least one external device, and activated one or more communication links among communication links for providing the streaming service.

6. The method of claim 2, wherein the driving performance of the processor comprises a driving performance of the processor in accordance to a system temperature of the electronic device.

7. The method of claim 1, wherein the transmitting to the server comprises:
detecting a first data quality according to a network speed for the streaming service; and
transmitting, to the server, information about a low data quality among the first data quality and a second data quality that is detected based on the status information of the electronic device.

8. The method of claim 1, further comprising:
determining, after transmitting the data quality to the server, whether the status information of the electronic device is changed;
determining, when the status information of the electronic device is changed, data quality for the streaming service based on the changed status information of the electronic device; and
transmitting the data quality to the server for the streaming service.

9. The method of claim 1, wherein the providing the streaming service comprises, when interlocking the streaming service with at least one external device, transmitting the streaming data provided from the server, to the at least one external device.

10. An electronic device comprising:
a display unit configured to display data;
a communication unit configured to connect communication with other devices; and
a processor configured to detect data quality for a streaming service based on status information of the electronic device, transmit the detected data quality to a server for the streaming service through the communication unit, and provide the streaming service using streaming data provided from the server through the communication unit.

11. The device of claim 10, wherein the processor comprises:
a collection unit configured to collect the status information of the electronic device;
a data quality determination unit configured to detect the data quality for the streaming service based on the status information of the electronic device; and
a communication control unit configured to transmit the data quality to the server for the streaming service through the communication unit, and receive streaming data from the server through the communication unit.

12. The device of claim 11, wherein the data quality determination unit detects, as the data quality for the streaming service, a low data quality among a first data quality according to a network speed for the streaming service and a second data quality detected based on the status information of the electronic device.

13. The device of claim 11, wherein, after transmitting the data quality to the server through the communication unit, when the status information of the electronic device collected through the collection unit is changed, the data quality determination unit detects the data quality for the streaming service based on the changed status information of the electronic device.

14. The device of claim 11, wherein, when interlocking the streaming service with at least one external device, the communication control unit transmits the streaming data provided from the server, to the at least one external device through the communication unit.

15. The device of claim 10, wherein the status information of the electronic device comprises one or more of a display variable of a region for displaying the streaming service, a number of communication links, remaining available data, and a driving performance of the processor.

16. The device of claim 15, wherein the display variable comprises one or more of a display variable of a region for displaying the streaming service in a display unit of the electronic device, and display variables of regions for displaying the streaming service in a display unit of an external device interlocking the streaming service with the electronic device.

17. The device of claim 15, wherein the display variable comprises one or more of a size, resolution, and transparency of a region for displaying the streaming service.

18. The device of claim 15, wherein the number of communication links comprises a number of at least one communication link through which the electronic device transmits/receives a signal with at least one external device, and activated one or more communication links among communication links for providing the streaming service.

19. The device of claim 15, wherein the driving performance of the processor comprises the driving performance of the processor in accordance to a system temperature of the electronic device.
